(19) United States
(12) Patent Application Publication
(10) Pub. No.: US 2012/0204504 A1
(43) Pub. Date: Aug. 16, 2012

(54) Fastening device for glass panes

(76) Inventor: FRIEDRICH KNAPP, Bad Kreuzen (AT)

(21) Appl. No.: 13/117,453

(22) Filed: May 27, 2011

Related U.S. Application Data
(63) Continuation of application No. 12/935,163, now abandoned.

(30) Foreign Application Priority Data
Apr. 2, 2008 (DE) 10 2008 017 169.7
Sep. 17, 2008 (DE) 10 2008 047 799.0

(51) Int. Cl. E06B 3/58; B29C 47/00

(52) U.S. Cl. 52/204.63; 264/171.1

(57) ABSTRACT

A fastening device for fastening glass panes in a wooden or plastic frame includes a plastic retaining rail fixable on the frame, and a clip strip mountable onto the retaining rail. The retaining rail has a fastening arm with a claw connectable with the frame by fasteners, and a clamping arm at a distance to the fastening arm. The clip strip has a groove for form-lockingly receiving the clip claw, and a groove for force-lockingly and/or form-lockingly receiving the clamping arm. The clip strip is form-lockingly held by the pre-stressed clamping arm and a free, non-secured section of the retaining rail is pressed against the glass pane by a permanent stressing force such that a seal between the retaining rail and the glass pane is pressed against the glass pane and the glass pane is pressed against a seal between the backside thereof and the stop of the frame.

The invention relates to a fastening device for fastening preferably glass panes in a frame construction made of wood or plastic. For fastening glass panes in window frames, among other things, so-called clip strip structures are used, such as described in DE 195 25 206, DE 296 00 399 U1, DE 42 16 260 C2 or DE 199 55 639 A1.

With such constructions, it is necessary that the glass panes are held in the frame very reliably. As frames made of aluminum are concerned, several profiles are used, which, together with rubber seals, enable good sealing and stability to be gained over a long period of time. However, now as before, window frames made of wood are used, and with such frames also, high sealing capability is required increasingly. Arrangements like those known from frames of aluminum can not be used for frames of wood, because the production of such frames is more time-consuming and costly than that of frames of wood.

Therefore, object of the invention is to provide a fastening device for fastening glass panes in a wooden or plastic frame, which is superior to any of the conventional clip strip structures with respect to sealing capability and stability and, nevertheless, can be made in a cost-effective way.

This object is solved by a fastening device according to claim 1.

A fastening device for glass panes to be held in a wooden or plastic frame is provided. The frame comprises a rear stop to which the glass pane is pressed by means of the fastening device which is characterized by the following features: a retaining rail made of an elastic, that is, resilient plastic, which can be fixed on a wooden or plastic frame. An expert will chose a plastic material comprising an elastic rigidity such as technologically required for the temperature range considered. Besides, the plastic material must keep its elastic rigidity over the period of time in which the window is used, that is, it must have properties such that it is not deformed plastically and does not lose its elasticity when exposed to heat. Also, the plastic material chosen must have properties such that it does not become brittle or does not rupture when exposed to temperatures below zero degrees centigrade. Several plastic materials are available so that an expert can select the most suitable one.

The kind of fastening is chosen by an expert at his discretion. Preferred kinds of fastening are defined in sub-claims, such as fastening by shooting nails into the frame. A clip strip can be slipped onto the retaining rail so that a form-locked junction is made. An elastic sealing each is provided between one side of the glass pane and the rear stop of the frame and the other side of the glass pane and the retaining rail. The retaining rail has a fastening arm provided with a clip claw. In addition, the retaining rail has a clamping arm. The fastening arm and the clamping arm extend perpendicularly to the glass pane, in the main, and in a predetermined distance to each other. The clip strip is provided with a groove arranged and geometrically dimensioned so that, when the clip strip and the retaining rail are in the connected state, the clip claw engages into this groove in a form-locked manner. In addition, the clip strip is provided with another groove arranged and geometrically dimensioned so that, when the clip strip and the retaining rail are in the connected state, the clamping arm is in engagement with this groove in a force-locked or a force- and form-locked manner.

Especially, it must be mentioned that the geometries of the retaining rail and the clip strip are chosen so that the clip strip is firmly held and the non-fixed section of the retaining rail is permanently pressed against the glass pane as soon as the clip strip is clipped onto the retaining rail. Thereby, the seal arranged between the vertical section of the retaining rail and the glass pane is pressed against the glass pane. Simultaneously, the glass pane is pressed against the seal arranged between back side thereof and the stop provided on the frame. Effected by the form-locked junction between the clip claw of the retaining rail and the respective groove in the clip strip, the fastening device can not become loose. As the retaining rail and the seals are slightly elastic, a permanent pressure against the glass pane is generated by them, which is permanently maintained by the form-locked junction.

Furthermore, the invention is advantageous in that the assembly, in which the clip strip and the retaining rail engage one into another, is a very rigid unit which can not loosen of itself and, therefore, the glass panes are fixedly held in the frame when being caused to vibrate continuously by wind, and also the fastening device does not become loose.

According claim 2, the clamping arm is provided with a claw which engages into the respective groove in the clip strip to set up a force- and form-locked junction. Thereby, a still better connection of the clip strip with the retaining rail and, thus, a more reliable clamping of the glass pane is gained.

According to claim 3, the clamping arm comprises holes for receiving fixing screws. It is well known that screws enable especially reliable connections to be gained.

According to claim 4, the fastening arm comprises a nail groove which serves as guide for driving in nails manually or for employing a nailing device reliably.

An expert knows that the features according to claims 3 and 4 can be combined.

According to claim 5, the fastening arm comprises a fastening web. Such a fastening web requires a respective groove to be cut into the window frame.

According to claim 6, the bottom surface of the retaining rail is provided with a recess for receiving a seal lip or a seal tape. With this arrangement, an effective water vapor lock is gained, because the retaining rail is pressed onto the window frame by means of a high pressure.

According to claim 7, the seals are fixedly connected with the retaining rail, that is, they are integral parts thereof. This enables the fastening device to be mounted quickly. This is the best embodiment of the invention. Seals fixedly connected with the retaining rail are always held at the accurate position and can not get out of place, compared with structures where the seals have to be inserted manually when the fastening device is mounted, with mounting errors possibly occurring.

According to claim 8, a method for producing a fastening device according to claim 6 is claimed, wherein the retaining rail is made according to an extrusion process, in which the seal is simultaneously formed on it.

In the following, the invention will be explained in detail by means of drawings, wherein parts or sections having the same features are marked by the same reference symbols.

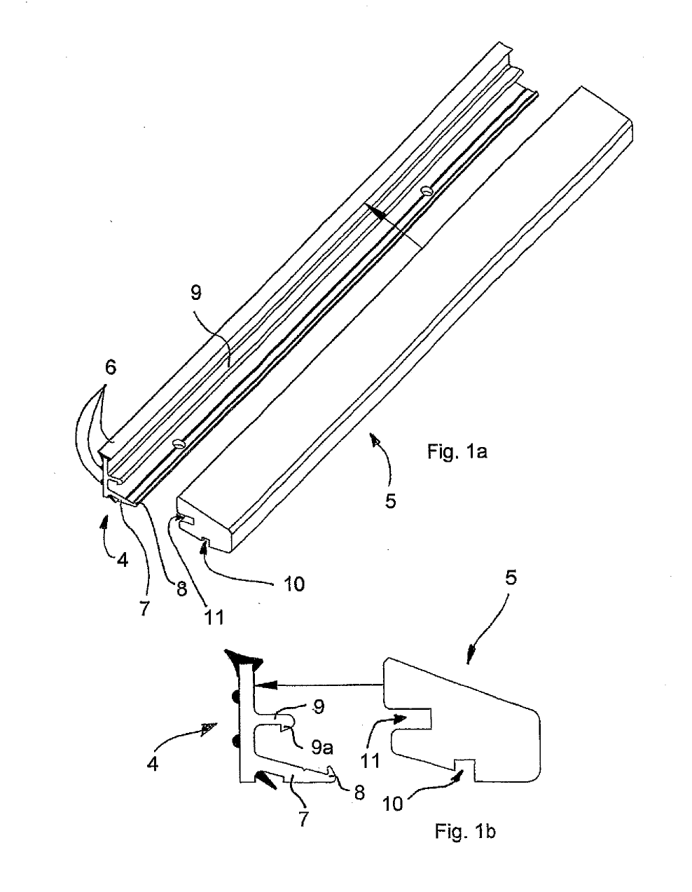

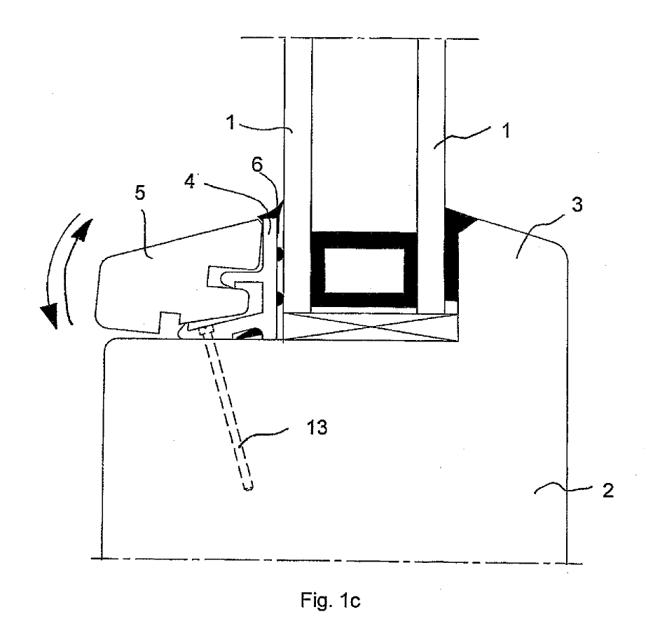

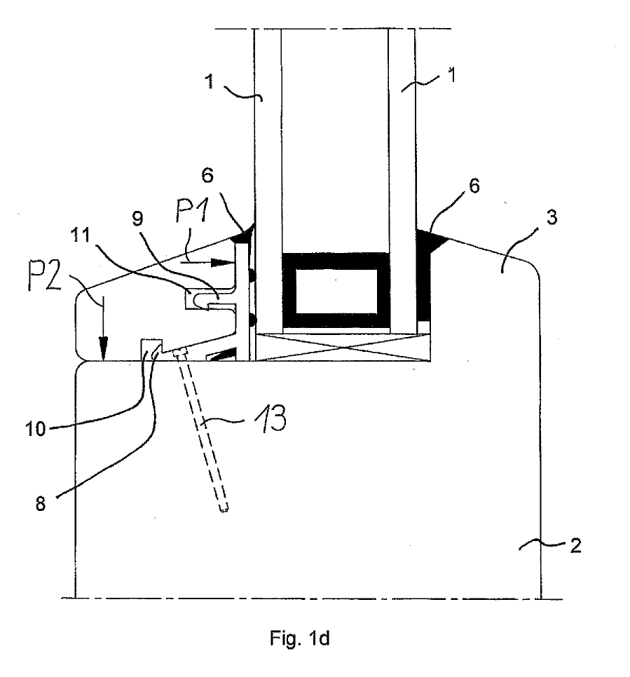

FIGS. 1a-d show a first fastening device for glass panes.

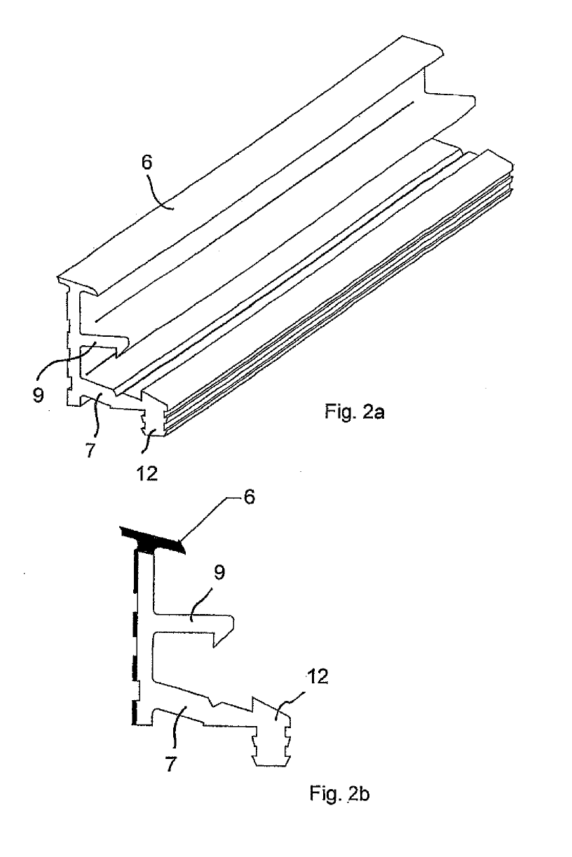

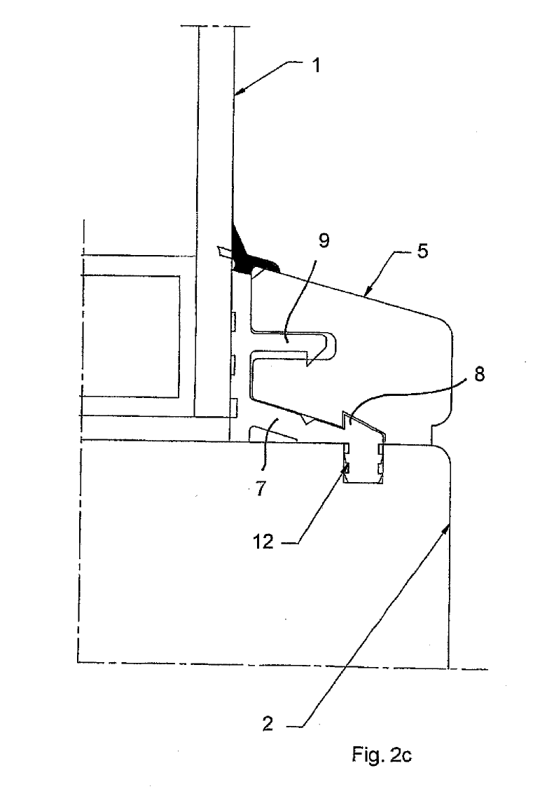

FIGS. 2a-c show a second fastening device for glass panes.

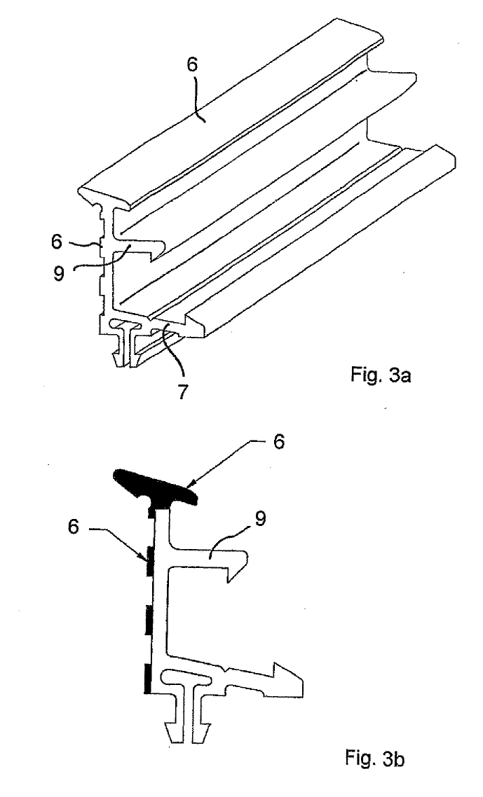

FIGS. 3a-b show a third fastening device for glass panes.

FIG. 1a is a perspective view of a retaining rail 4 made of plastic material and of a clip strip 5 made of wood or plastic material. FIG. 1b shows a cross-sectional view of the retaining rail 4 and the clip strip 5. The arrow indicates that the clip strip 5 is pushed onto the retaining rail 4.

FIG. 1c shows the mounting of the clip strip 5 onto the retaining rail 4. Reference symbol 2 marks the cross section of a window frame having a rear stop 3 against which a compound arrangement of two glass panes 1,1 is pressed. The retaining rail is fastened to the window frame by nails 13 through its fastening arm 7. A clip claw 8 is formed at the outermost end of the fastening arm 7. A clamping arm 9 with a claw 9a formed at the outermost end thereof extends outwardly and in a predetermined distance to the fastening arm 7. The clip strip 5 comprises two grooves, a groove 10 for receiving the fastening arm 7, which is arranged and geometrically shaped so that, when the fastening arm 7 is inserted, its claw 8 is in engagement with the groove 10 in a form-locked manner, and a groove 11 for receiving the clamping arm 9, which is arranged and geometrically shaped so that, when the clamping arm 9 is inserted, its claw 9a is in engagement with the groove 11 in a force- and form-locked manner. The cross-sectional geometry of the clip strip 5 enables this strip to be mounted onto the clamping arm easily, caused by its inclined bottom surface, that is, the clip strip 5 is pushed onto the retaining rail 4 until the clip claw 8 snaps into the groove 10. When the clip strip 5 is pushed onto the retaining rail 4, it is slightly tilted upwardly, but tilts downwardly again as soon as the clip claw 8 snaps into the groove 10, as indicated by the two arrows. The geometries of the grooves and the arms are chosen so that the clamping arm 9 remains slightly tilted upwardly when the clip strip 5 has reached its final position. This is a substantial feature of the invention.

FIG. 1d shows the state when assembling is completed, that is, when the clip claw 8 is in engagement with the groove 10. Arrow P1 indicates that the vertical section of the retaining rail 4 is permanently pressed against the glass pane 1. Caused by the form-locked junction between the clip claw 8 and the groove 10, this permanent contact pressure is maintained. Arrow P2 indicates that the clip strip 5 is pressed onto the frame 2 and, in a form-locked manner, onto the retaining rail, effected by the elastic force of the pre-stressed clamping arm 9.

FIGS. 2a, b show a fastening arm 7 having a fastening web 12. This fastening web 12 requires a respective groove to be cut into the window frame. This embodiment of the invention enables the assembling to be carried out more quickly, in the site.

FIGS. 3a, b show an embodiment similar to that represented in FIGS. 2a, b.

Based on then technical science disclosed and claimed, an expert will be able to find out further embodiments, without having to be active inventively.

1. Fastening device for fastening glass panes (1) in a wooden or plastic frame (2) comprising a rear stop (3) against which the glass pane (1) is pressed by means of the fastening device, wherein the fastening device is characterized by the following elements and features:
a. a retaining rail (4) made of elastic plastic, which is fixable on a frame made of wood or plastic,
b. a clip strip (5) mountable onto the retaining rail, and
c. an arrangement of elastic seals (6), wherein
the retaining rail (4) has
a fastening arm (7) provided with a claw 8, which is connectable with the wooden or plastic frame (2) by means of fastening elements (13), and
a clamping arm (9) arranged in a distance to the fastening arm (7), and
the clip strip (5) comprises
a groove (10) for receiving the clip claw (8), which is arranged and geometrically dimensioned such that, in the connected state, the clip claw (8) is in engagement with the groove (10) in a form-locked manner, and
a groove (11) for receiving the clamping arm (9), which is arranged and geometrically dimensioned such that, in the connected state, the clamping arm (9) is in engagement with the groove (11) in a force-locked or a force- and form-locked manner, wherein
the geometries of the retaining rail (4) and the clip strip (5) are chosen so that
the clip strip (5) is held in the form-locked manner by the pre-stressed clamping arm after engaging and
that section of the retaining rail (4), which is not fixed and, thus, is movable freely, is pressed against the glass pane (1) by a permanent stressing force such that the seal (6) arranged between the retaining rail (4) and the glass pane (1) is pressed against the glass pane (1) and, simultaneously, the glass pane (1) is pressed against the seal (6) arranged between the backside thereof and the stop (6) which the frame (2) is provided with.

2. Fastening device according to claim 1, characterized in that the clamping arm (9) is provided with a claw (9a).

3. Fastening device according to claim 1 or 2, characterized in that the fastening arm (7) comprises holes for receiving fixing screws.

4. Fastening device according to claim 1 or 2, characterized in that the fastening arm (7) comprises a groove for driving in nails.

5. Fastening device according to claim 1 or 2, characterized in that the fastening arm (7) comprises a fastening web (12).

6. Fastening device according to any of the preceding claims, characterized in that the retaining rail (4) comprises a recess provided on the bottom surface thereof, in which a sealing lip or a sealing tape is arranged.

7. Fastening device according to any of the preceding claims, characterized in that the seals (6) and the retaining rail (4) are formed in one piece.

8. Method for producing a fastening device according to claim 7, characterized in that the retaining rail (4) is made according to a extrusion process, in which the seals (6) are simultaneously formed on the retaining rail (4).
